(19) United States
(12) Patent Application Publication
(10) Pub. No.: US 2005/0180607 A1
(43) Pub. Date: Aug. 18, 2005

(54) Method for conducting automated surface inspection and surface correction

(75) Inventors: Gunther Pabst, Mannheim (DE); Georg Igl, Weissach (DE); Klaus Dieter Horner, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwugshafen (DE)

(21) Appl. No.: 10/505,450

(22) PCT Filed: Mar. 12, 2003
(86) PCT No.: PCT/EP03/02507

(51) Int. Cl. G06K 9/00

(52) U.S. Cl. 382/110

(57) ABSTRACT

An automated method for surface monitoring and surface correction of sheet-like materials, for example of leather, especially a method for classifying surfaces of sheet-like materials, comprises the following steps: (a) preparation of a material, (b) optoelectronic recording of the surface of the material, (c) determination of the number of defects, (d) determination of the volume of defects, and subsequent automatic classification of the sheet-like materials according to number and volume of defects.

The present invention relates to an automated method for classifying sheet-like materials, comprising the following steps:
(a) preparation of a material,
(b) optoelectronic recording of the surface of the material,
(c) determination of the number of defects,
(d) calculation of the volume of defects
   and subsequent classification of the sheet-like materials according to number and volume of defects.

Uniform surfaces of sheet-like materials and engineering materials are of considerable economic interest. These may be, for example, laminate surfaces or marble. Even small defects can decisively reduce the value of the material. The quality control, which has to be carried out manually with great care in particular when evaluating high-quality materials, therefore gives rise to considerable costs.

In particular, very uniform leather having good mechanical strength is now of considerable economic importance since it can be processed with very little loss. A leather having a surface which as far as possible has been left with its natural appearance, also known to a person skilled in the art as natural grain, is of particular economic value. Every tannery makes an effort to produce a very high proportion of high-quality leathers. Leather and the starting material, i.e. the animal skins, therefore always pass through numerous checks. After the actual tanning, the leather is hydroextracted and manually checked, i.e. the tanner handles each individual skin, examines it, detects and marks defects, in particular rawhide damage, and then classifies them in 5 different quality levels. This manual check is repeated after other steps in leather production, for example with the rawhides, after retanning and after finishing, and the check is very expensive.

Tanneries suffer considerable economic losses through surface defects, such as rawhide damage to the skins, and due to superficial manufacturing defects. Rawhide damage is understood as meaning those low-quality areas of the leather which the relevant animal has suffered, during its life, for example due to tears by barbed wire, currycomb tears, tears by thorns, pricks from driving prongs or manure forks, abrasion areas, injuries from horn thrusts, burns on the animals, dung marks and cockchafer grub damage by, for example, gadflies. Rawhide damage can scarcely be avoided, even with animal keeping suitable for the species, and results in relatively large parts of the leather no longer being suitable for high-quality applications, for example for automobile seats or high-quality shoes. Particularly deep rawhide damage, for example deep tears, prevent the utilization of the corresponding leather for the production of large-area, uniform secondary leather products, for example for furniture or automobile leather seats. This leads to a considerable reduction in the value of the leather.

Superficial manufacturing defects include, for example, scraping damage. Further superficial manufacturing defects which result in impairment are, for example, color differences caused, for example, by illnesses, preservation damage, for example due to eating by beetles, and furthermore scalding damage.

There has been no lack of attempts to minimize the losses which tanneries suffer through rawhide damage and/or superficial manufacturing defects. The proposals for improvement are divided into those methods which are concerned with the detection of rawhide damage and/or superficial manufacturing defects and those which are concerned with correction. However, the methods known to date have disadvantages.

There has likewise been no lack of attempts to detect the rawhide damage and/or superficial manufacturing defects mechanically.

DE 42 16 469 discloses an apparatus for classifying skins, in which defects are qualitatively determined by an infrared camera and quantitatively evaluated. The method is carried out after the first chrome tanning. Skins of relatively poor quality are manually removed and are no longer processed. The losses of material are therefore not reduced compared with the conventional methods.

DE 42 30 068 discloses a method for non-contact checking of the surface roughness of the materials, especially of leather or imitation leather. From the values measured with the aid of an optical reflection measuring apparatus, a spatial frequency spectrum is assigned with the aid of a Fourier transformation, after which the characteristic spectral components due to the roughness, i.e. due to holes and other irregularities of the surface, are analyzed and are compared with the predetermined required values. The method is used merely for evaluating leather, and further possible uses are not disclosed. Moreover, the evaluation must once again be carried out manually.

DE 42 31 222 C1 discloses a method for typifying and marking defects in natural leather. Different quality zones are first manually marked, for example by marking with a fluorescent marker or by placing a cord around them. In each case spheres are accommodated in different quality zones and the number and size of the spheres are then determined by means of a camera. This method is said to be suitable as preparation for subsequent automatic nesting—which is understood as meaning automatic computer-assisted laying of the stamping pattern parts, on the basis of which a machine then cuts out the stamping patterns—but requires a great deal of expensive manual work.

DE 197 37 703 discloses a method and an apparatus for the detection, quantification and qualification of defects and defective areas in animal skins. In the method, the spread-out skins are illuminated with light of a plurality of colors and then photometrically evaluated. The defects are then included in lists and the leathers are distributed over various stacks. Leather of relatively high quality is then sent, for example, to the shoe industry, whereas use in the furniture industry is proposed for leather of lower quality. A remedy as to how wastes in leather production and utilization could be reduced or avoided is not proposed.

WO 97/29368 discloses a visual inspection system for skins, consisting of three-dimensional scanning of the stretched skin surface with a light source and subsequent translation into an algorithm. The method disclosed is suitable for the mapping and analysis of skins, in particular with regard to concealed defects. The method disclosed does not propose how wastes in leather production and utilization can be reduced or avoided.

EP 1 107 377 discloses a method and an apparatus for determining the quality of the surface structure of skins, which is based on the determination of the peak-to-valley height by means of optical methods. The publication merely proposes a listing of the defects and rawhide damage but gives no indication as to how wastes in leather production could be reduced or avoided.

Common to the methods known from the prior art for eliminating rawhide damage is that they accept considerable material losses or a reduction in the quality of the material and are dependent on a great deal of manual work.

It is possible to inspect the skins after tanning and to punch out good areas in order to use them for high-quality applications. However, it is necessary either to dispose of the remaining skin or to use it for applications having lower quality requirements, which means considerable material and financial losses.

It has long been customary to buff the grain of those leathers which have many rawhide defects or large areas of rawhide damage and/or superficial manufacturing defects—and this amounts in practice to more than 80% of the leathers—in order thus to permit level, i.e. uniform finishing. For tanneries, however, this means considerable financial losses because, on the one hand, this method entails a considerable cost in terms of personnel, chemicals and machines and, on the other hand, a value-determining part of the leather is lost with the grain removed by buffing, resulting in a lower achievable price for the tanner. Finally, the value of the leather decreases, and the method therefore results in a reduction in the value of the leather.

Methods are also known in which, after removal of the natural grain by buffing, an artificial grain is applied, for example by applying a polymer dispersion and allowing it to cure and embossing it with an artificial negative grain. This produces an artificial grain, which, however, is in general less valuable.

A further conventional technique is stuccoing, i.e. the application, for example of an aqueous polymer dispersion, especially a polymer solution, over a large area of the grain which has been only slightly removed or not removed at all by buffing. In general, this means a considerable manual effort. Moreover, the quality of the leather is generally greatly reduced since, for example, the elasticity of the leather is decreased. In addition, a certain shrinkage is generally observed during curing of the polymer dispersions, so that the rawhide damage and/or superficial manufacturing defects are not in the end perfectly compensated.

It is an object of the present invention in general to provide a method for classifying sheet-like materials which avoids the disadvantages known from the prior art.

It is in particular an object of the present invention to provide a method for classifying and upgrading sheet-like materials, by means of which the wastes, in particular in leather production, can be reduced and high-quality materials can be produced. In particular, it is an object of the present invention to provide a method by means of which high-quality leathers can be produced from skins having surface defects, for example rawhide defects and/or superficial manufacturing defects. It is furthermore an object of the present invention to provide an apparatus by means of which surface defects of leather can be eliminated and hence the quality of the leather upgraded.

We have found that this object is achieved by the method defined at the outset.

The novel automated method comprises a plurality of steps.

The novel method starts from any desired sheet-like materials. Examples are marble, and furthermore laminates for, for example, floor applications. The sheet-like materials are locked.

In the present invention, this step is referred to as preparation of a material (a).

The novel method preferably starts from pretanned, tanned or completely tanned skins, which are summarized below by the general term leather. The leather is usually sammed and hydroextracted in accordance with known methods so that the water content of the-leather is 70% by weight or less, preferably 40% by weight or less, based on the shaved weight. After hydroextraction, the leather is spread out and flattened, which can be effected by methods likewise known per se. The leather can be spread out by clamping in a tension apparatus. The flattening is preferably effected using a vacuum table, as described, for example, in DE-A 198 22 224.

In the present invention, the steps mentioned above are also referred to as preparation of the leather (a).

In step (b), optoelectronic recording of the surface of the material is carried out. The optoelectronic recording of the surface comprises three-dimensional imaging which can be carried out by methods known per se, for example with the aid of one or more sensor units, in particular cameras. Preferably, only one sensor unit is used, in particular exactly one camera, for example a CCD camera.

Preferably, the sensor units, in particular the one sensor unit, are or is mounted on a movable unit, in particular a carriage, and are or is moved under computer control over the prepared material, in particular over the prepared leather.

The detection of defects by one or more sensor units can be supported by exposure to one or more light sources or radiation sources, which are known in principle from the prior art, for example DE 39 28 095, DE 197 37 703, WO 97/2936, DE 42 16 469, DE 198 24 304 and DE 42 30 068.

A topographical profile of the surveyed surface of the material, in particular of the leather surface, is then calculated, for example with the aid of the known triangulation principle. A height and depth image of the surface with mountains and valleys is obtained.

The triangulation principle as such and computer programs for carrying it out, for example the OptoCAT program for Windows NT, are known. Reference may be made to E. Klaas, World Leather 2001, Issue 9, page 44, by way of example.

Automated defect detection is then carried out, which comprises determining the number, position and size, in particular depth and volume, of the defects. For this purpose, the computer program initially defines a plane of fit, which is applied to the material depending on requirements. In general, programs apply planes of fit in such a way that they correspond to an average value for the surface.

From the deviation of the mountains and valleys of the height and depth image from the plane of fit, it is possible to calculate points which are above or below the set required value.

The deviations from the required plane can be represented topographically with the aid of known computer programs, as disclosed, for example, in DE 42 30 068. Mountains and valleys which are attributable to cavities, caused, for example, by tears or holes, and projections are usually observed.

From the depth and area information of the topographical representation, the number of defects is determined in step (c) and the size, for example radius, depth and in particular volume of the surface defects, in step (d). The conventional programs usually perform this step directly. The conventional programs usually store the position of the surface defects.

On the basis of the number and of the calculated defect volumes, the prepared materials are automatically classified according to the invention. In particular, automatic classification of the leather is effected according to number and volume of all surface defects. The classification of the materials is performed by the computer program on the basis of the criteria known to a person skilled in the art and takes into account the conventional requirements for the material. The novel classification is usually effected within a short time, and the result immediately stored.

In a preferred embodiment, small projections of the material, in particular of the leather, caused by, for example, scars, warts or ulcers, are immediately selectively cut off by means of a cutter, which may likewise be mounted on the carriage. The cutting off may be effected after step (b) or after step (d) described below.

In a preferred embodiment of the novel method, steps (a) to (d) and preferably the automatic classification are followed by a further step, i.e.

(e) repair of the defects using one or more binders.

In step (e), the surface defects which appear as cavities, for example as holes, indentations or scratches in the laminate or in the marble, are repaired by selective addition of a binder or of a mixture of binders. Binders known per se, for example physically or thermally curable binders or binders curable by actinic radiation, are used for this purpose.

In step (e), in particular those surface defects of the leather which lead to cavities, for example to holes or tears, are repaired by selective addition of a binder or of a mixture of binders. Binders known per se, for example physically curable binders, thermally curable binders or binders curable by actinic radiation, are used for this purpose.

Usually, one or more binders in the form of a dispersion or emulsion, preferably in the form of an aqueous dispersion or emulsion, are used for effecting the curing thereof, i.e. the chemical crosslinking of the binder itself, or for effecting the physical drying of the binder dispersion or emulsion.

Radiation-curable or thermally curable binders or binders drying by atmospheric oxidation, i.e. air-drying binders, i.e. chemically crosslinking binders, or physically drying binder dispersions or emulsions, in which the liquid phase, for example water or an organic solvent, evaporates, can be used.

The radiation-curable binders which are used in the novel method can cure by means of high-energy radiation, i.e. electromagnetic radiation, in particular from 220 to 450 nm, or electron beams. Binder components capable of free radical and cationic polymerization and mixtures thereof are suitable for this purpose. Such binders are known as such and are described, for example, in Chemistry and Technology of UV and EB Formulation for Coatings, Inks and Paints, SITA Technology, London 1991; UV and EB Curing Formulation for Printing Inks and Paints, SITA Technology, London 1991, and Vinyl Ethers—The innovative Challenge, company publication of BASF Aktiengesellschaft, 1997.

Examples are binders based on one or more of the following parent substances: butadiene, 2-ethylhexanoate, n-hexyl acrylate, n-butyl acrylate, ethyl acrylate, vinylidene chloride, isobutyl acrylate, vinyl propionate, methyl acrylate, lauryl acrylate, n-butyl methacrylate, vinyl acetate, ethyl methacrylate, styrene, acrylonitrile, methyl methacrylate, acrylic acid, methacrylic acid, acrylamide and methacrylamide.

Examples of radiation-curable binders are acrylate-containing, vinyl-containing, urethane-containing and epoxide-containing monomers, prepolymers and polymers and mixtures thereof.

The acrylate-containing binders are in particular acrylate- or methacrylate-based prepolymers, acrylate-based prepolymers being particularly preferred.

Preferred-acrylates and methacrylates contain, as a rule, from 2 to 20, preferably from 2 to 10, and particularly preferably from 2 to 6, copolymerizable ethylenically unsaturated double bonds per molecule. The average molecular weight Mn is preferably ≦15 000 g, particularly preferably ≦5 000 g and very particularly preferably from 180 to 3 000 g, determined by gel permeation chromatography (GPC) using polystyrene as standard and THF as eluent.

Examples of suitable (meth)acrylate compounds are (meth)acrylates and preferably acrylates of polyhydric alcohols, in particular those which contain only ether groups or no further functional groups apart from the hydroxyl groups. Examples of such alcohols are dihydric alcohols, such as ethylene glycol, propylene glycol and higher condensates, such as diethylene glycol, triethylene glycol, dipropylene glycol, tripropylene glycol, and moreover 1,3-propanediol, 1,2-butanediol, 1,4-butanediol, 1,2-pentanediol, 1,2-hexanediol, 1,6-hexanediol, neopentylglycol, alkoxylated phenols and bisphenols, for example ethoxylated bisphenol A, and cyclohexanedimethanol. Furthermore, trihydric alcohols, for example glycerol, trimethylolpropane, 1,2,4-butanetriol, 1,2,3-butanetriol or trimethylolethane, are suitable. Finally, alcohols having a higher functionality, for example pentaerythritol, ditrimethylolpropane, dipentaerythritol, sorbitol, mannitol and the corresponding alkoxylated, in particular ethoxylated or propoxylated, derivatives, may also be mentioned.

The alkoxylation products are obtainable in a known manner by reacting the corresponding alcohols with alkylene oxides, in particular ethylene oxide and propylene oxide. Catalysts which may be used are acidic compounds, for example SbCl₅, or basic compounds, for example NaOCH₃.

Further examples of methacrylate compounds are polyester(meth)acrylates, these being the (meth)acrylates of polyesterols, which may be saturated or unsaturated.

Suitable polyesterols are prepared, for example, by esterifying di- and polycarboxylic acids, preferably dicarboxylic acids, with polyols. Preferred dicarboxylic acids are succinic acid, glutaric acid, adipic acid, sebacic acid, maleic acid, fumaric acid, phthalic acid, isomers of phthalic acid and its hydrogenation products and esterifiable derivatives, for example anhydrides or dimethyl esters or diethyl esters of the abovementioned acids. Suitable polyols are ethylene glycol, propylene glycol and higher condensates, such as diethylene glycol, triethylene glycol, dipropylene glycol, tripropylene glycol, and moreover 1,3-propanediol, 1,2-butanediol, 1,4-butanediol, 1,2-pentanediol, 1,2-hexanediol, 1,6-hexanediol and polyalkylene glycols based on ethylene glycol and propylene glycol.

A good process for the preparation of the abovementioned (meth)acrylate compounds is described, for example, in EP-A 0 279 303.

Furthermore, the (meth)acrylate compounds may also be epoxy(meth)acrylates or urethane(meth)acrylates. Epoxy(meth)acrylates are obtainable, for example, by reacting epoxidized olefins or mono-, di- or polyglycidyl ethers, for example bisphenol A diglycidyl ether, with (meth)acrylic acid.

Urethane(meth)acrylates are in particular reaction products of hydroxyalkyl (meth)acrylates with di- or polyisocyanates.

Furthermore, the (meth)acrylate compounds may be melamine(meth)acrylates and silicone(meth)acrylates.

The (meth)acrylate compounds may also be ionically modified, for example with acid groups or ammonium groups, or nonionically modified, for example with amino groups. Moreover, they are preferably used in the form of aqueous dispersions or emulsions, which are disclosed as such in EP-A 0 704 469 and EP-A 0 012 339.

Furthermore, the (meth)acrylate compounds can be mixed with reactive diluents for adjusting the viscosity. Suitable reactive diluents are for example, vinyl-containing monomers, in particular N-vinyl compounds, such as N-vinylpyrrolidone, N-vinylcaprolactam and N-vinylformamide and

vinyl ethers, for example ethyl vinyl ether, propyl vinyl ether, n-butyl vinyl ether, isobutyl vinyl ether, sec-butyl vinyl ether, tert-butyl vinyl ether, amyl vinyl ether, 2-ethylhexyl vinyl ether, n-dodecyl vinyl ether, n-octadecyl vinyl ether and cyclohexyl vinyl ether, ethylene monoglycol vinyl ether and ethylene monoglycol divinyl ether, di-, tri- and tetraethylene glycol mono- and divinyl ether, propylene glycol divinyl ether, polyethylene glycol divinyl ether, ethylene glycol n-butyl vinyl ether, triethylene glycol methyl vinyl ether, polyethylene glycol methyl vinyl ether, 1,4-butanediol mono- and divinyl ether, 1,6-hexanediol mono- and divinyl ether, cyclohexanedimethanol mono- and divinyl ether, trimethylolpropane mono- and divinyl ether, aminopropyl vinyl ether, diethylaminoethyl vinyl ether and polytetrahydrofuran divinyl ether;

vinyl esters, for example vinyl acetate, vinyl propionate, vinyl stearate and vinyl laurate,

vinylaromatics, for example styrene, vinyltoluene, 2- and 4-n-butylstyrene and 4-n-decylstyrene;

and acrylate-containing monomers, for example phenoxyethyl acrylate, tert-butylcyclohexyl acrylate, 1,6-hexanediol diacrylate, tripropylene glycol diacrylate and trimethylolpropane triacrylate.

Vinyl-containing compounds can also be used directly as cationically polymerizable binders.

Other suitable radiation-curable binders are epoxy-containing compounds, for example cyclopentene oxide, cyclohexene oxide, epoxidized polybutadiene, epoxidized soybean oil, 3′,4′-epoxycyclohexylmethyl 3,4-epoxycyclohexanecarboxylate and glycidyl ethers, for example 1,4-butanediol diglycidyl ether, 1,6-hexanediol diglycidyl ether, bisphenol A diglycidyl ether and pentaerythrityl diglycidyl ether, it also being possible for cationically polymerizable monomers, for example unsaturated aldehydes and ketones, dienes, such as butadiene or isoprene, vinylaromatics, such as styrene, N-substituted vinylamines, such as N-vinylcarbazole, and cyclic ethers, such as tetrahydrofuran, to be concomitantly used.

Examples of urethane-containing binders are condensates of at least difunctional isocyanates, which serve as linkage points, with a polymeric compound which is terminated at one chain end by a group reactive with isocyanate (referred to below as stabilizer block) and a (homo- or co-)polymer of a nitrogen-containing monomer which in each case has a group reactive with isocyanate and becomes attached to the solid particles to be dispersed (referred to below as anchor group block).

The isocyanate which links stabilizer block and anchor group block is a diisocyanate or a higher-functional polyisocyanate having an average NCO functionality of from 2.0 to 4.5.

The diisocyanates may be aromatic or aliphatic, preferably aliphatic diisocyanates, such as tetramethylene diisocyanate, hexamethylene diisocyanate, octamethylene diisocyanate, decamethylene diisocyanate, dodecamethylene diisocyanate, tetradecamethylene diisocyanate, trimethylhexane diisocyanate, tetramethylhexane diisocyanate, 1,4-, 1,3- or 1,2-diisocyanatocyclohexane, 4,4′-di(isocyanatocyclohexyl)-methane, 1-isocyanato-3,3,5-trimethyl-5-(isocyanatomethyl)-cyclohexane(isophorone diisocyanate) and 2,4- and 2,6-diisocyanato-1-methylcyclohexane, hexamethylene diisocyanate and isophorone diisocyanate being particularly preferred.

The higher-functional polyisocyanates may likewise be aromatic or aliphatic. Here too, the aliphatic polyisocyanates are preferred, especially those having an average NCO functionality of from 1.7 to 5, in particular about 3. Examples are the following groups:
1. Isocyanurate-containing polyisocyanates of aliphatic and/or cycloaliphatic diisocyanates. Particularly preferred here are the corresponding isocyanatoisocyanurates based on hexamethylene diisocyanate and isophorone diisocyanate. These isocyanurates are in particular simple trisisocyanatoalkyl or trisisocyanatocycloalkyl isocyanurates, which are cyclic trimers of the diisocyanates, or mixtures with their higher homologs having more than one isocyanurate ring. The isocyanatoisocyanurates generally have an NCO content of from 10 to 30, in particular from 15 to 25,% by weight and an average NCO functionality of from 2.6 to 4.5.
2. Uretdione diisocyanates having aliphatically and/or cycloaliphatically bonded isocyanate groups, which are preferably derived from hexamethylene diisocyanate or isophorone diisocyanate. Uretdione diisocyanates are cyclic dimerization products of diisocyanates.
3. Biuret-containing polyisocyanates having aliphatically bonded isocyanate groups, in particular tris(6-isocyanatohexyl)-biuret or its mixtures with its higher homologs. These biuret-containing polyisocyanates generally have an NCO content of from 18 to 25% by weight and an average NCO functionality of from 3 to 4.5.
4. Urethane- and/or allophanate-containing polyisocyanates having aliphatically or cycloaliphatically bonded isocyanate groups, as can be obtained, for example, by reacting excess amounts of hexamethylene diisocyanate or of isophorone diisocyanate with simple polyhydric alcohols, such as trimethylolpropane, glycerol, 1,2-dihydroxypropane or mixtures thereof. These urethane- and/or allophanate-containing polyisocyanates generally have an NCO content of from 12 to 20% by weight and an average NCO functionality of from 2.5 to 3.
5. Oxadiazinetrione-containing polyisocyanates, preferably derived from hexamethylene diisocyanate or isophorone diisocyanate. Such oxadiazinetrione-containing polyisocyanates can be prepared from diisocyanate and carbon dioxide.
6. Uretonimine-modified polyisocyanates.

The polymeric compound forming the stabilizer block is preferably a polymeric compound of the formula A
R¹—Yₓ—XH A
where
R¹ is hydrogen,
C₁-C₂₈-alkyl, preferably C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl and n-decyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl and sec-hexyl, particularly preferably C₁-C₄-alkyl, such as methyl, ethyl, n-propyl, isopropyl, n-butyl, isobutyl, sec-butyl and tert-butyl,
C₂-C₂₈-alkenyl having one or more double bonds, substituted or unsubstituted, for example vinyl, 1-allyl, 3-allyl, ω-butenyl, ω-pentenyl, ω-hexenyl, ω-decenyl, ω-undecenyl, ω-eicosenyl, 1-cis-buta-1,3-dienyl or 1-cis-hexa-1,5-dienyl. Among the substituted C₂-C₂₈-alkenyl groups, the following may be mentioned by way of example: isopropenyl, 1-isoprenyl, α-styryl, β-styryl, 1-cis-1,2-phenylethenyl or 1-trans-1,2-phenylethenyl,
C₂-C₂₈-alkynyl having one or more triple bonds, substituted or unsubstituted and optionally having double bonds, for example ethynyl, propargyl, ω-butynyl, but-2-ynyl, ω-pentynyl, pent-2-ynyl, pent-3-ynyl, 2-methylpent-3-ynyl, ω-hexynyl, ω-decynyl, ω-undecynyl, ω-eicosynyl,
or a radical of a polymerization initiator or of a chain regulator,
Y are identical or different polymerized units of monomers, selected from α,β-ethylenically unsaturated mono- or dicarboxylic acids, unsubstituted or hydroxyl-, C₁-C₆-alkoxy-, polyalkylenoxy- or halogen-monosubstituted or polysubstituted C₁-C₂₀-(cyclo)alkyl or C₇-C₂₀-aralkyl esters, amides, nitriles or anhydrides of α,β-ethylenically unsaturated mono- or dicarboxylic acids, vinyl or allyl esters of aliphatic or aromatic carboxylic acids, vinyl or allyl ethers, ethylenically unsaturated sulfonic acids or sulfonic acid derivatives, unhalogenated or halogenated ethylenically unsaturated aliphatic C₂-C₂₀-hydrocarbons, aromatic ethylenically unsaturated compounds or compounds which can be polymerized to give polyphosphacenes, or are 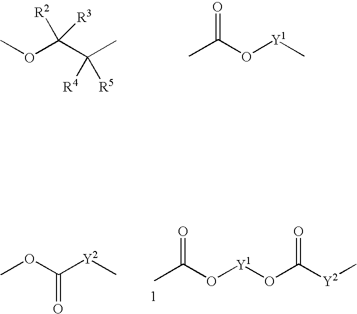
   where
R² to R⁵, independently of one another, are hydrogen,
C₁-C₆-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl and sec-hexyl, particularly preferably C₁-C₄-alkyl, such as methyl, ethyl, n-propyl, isopropyl, n-butyl, isobutyl, sec-butyl and tert-butyl,
C₆-C₂₀-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl,
—CH₂—Cl or —CH₂—OH,
and Y¹ and Y², independently of one another, are C₂-C₂₀-alkylene, C₆-C₁₄-arylene for example p-phenylene or m-phenylene, or aralkylene,
x is an integer from 0 to 10 000, x preferably being greater than or equal to 2, in particular greater than or equal to 3, particularly preferably from 30 to 1 000, and
X is COO, O, S or NR⁶, where R⁶ is H or C₁-C₆-alkyl which is as defined above.

One or more C₁-C₈-alkyl (meth)acrylates are preferably used for synthesizing the polymeric compound A. Particularly preferably one or more C₁-C₄-alkyl methacrylates, in particular methyl methacrylate and/or butyl methacrylate, are polymerized. The group XH reactive with isocyanate is preferably a hydroxyl group, which can be introduced terminally into the polyacrylate with the aid of initiators which give a hydroxyl radical on decomposition and/or with the aid of chain regulators which contain a hydroxyl group.

Very particularly preferred polymeric compounds A are mono- (as a rule C₁-C₁₈-, preferably C₁-C₄-)alkyl ethers of poly- (in particular C₂-C₄-)alkylene glycols, which can be obtained, for example, by reacting an alkanol with alkene oxides, such as ethylene oxide., propylene oxide, butylene oxide or epichlorohydrin. C₁-C₁₈-alkanols, in particular C₁-C₄-alkanols, alkoxylated with from 5 to 10 000, preferably from 5 to 80, mol of ethylene oxide and/or propylene oxide are particularly suitable, polyethylene glycol monomethyl ether being very particularly suitable.

The weight average molecular weight of the stabilizer block is preferably from about 250 to 100 000, in particular from about 500 to 7 000.

An embodiment of the anchor group block which is suitable for synthesizing the dispersant A is based on homo- or copolymers of one or more monomers from the group consisting of the N-vinylamides, N-vinyllactams and vinyl- or allyl-substituted nitrogen-containing heterocycles. Examples of particularly suitable monomers are N-vinylpyrrolidone, N-vinylpyridine, N-vinylcaprolactam, N-vinylimidazole and N-vinylformamide, N-vinylpyrrolidone being preferred. The homo- or copolymer preferably has a K value of from 10 to 100, in particular from 10 to 30. The termination by a hydroxyl group as a group reactive with isocyanate can be achieved by carrying out the polymerization in water or a lower alcohol, such as isopropanol, or by polymerization in the presence of a corresponding chain regulator and/or initiator.

Particularly when the binder is cured by means of UV radiation, it is advisable to introduce the binder together with a photoinitiator, which starts the polymerization, into the cavities, holes or tears in the leather.

Suitable photoinitiators for free radical photopolymerizations are, for example, benzophenone and benzophenone derivatives, such as 4-phenylbenzophenone or 4-chlorobenzophenone, acetophenone derivatives, such as 2-hydroxy-2,2-dimethylacetophenone and 2,2-dimethoxy-2-phenylacetophenone, 1-benzoylcyclohexan-1-ol, benzoin and benzoin ethers, such as methyl, ethyl and butylbenzoin ether, benzil ketals, such as benzil dimethyl ketal, 2-methyl-1-[4-(methylthio)phenyl]-2-morpholinopropan-1-one, acylphosphine oxides, such as 2,4,6-trimethylbenzoyldiphenylphophine oxide and bisacylphosphine oxides.

Examples of photoinitiators suitable for cationic photopolymerizations are
aryldiazonium salts, for example 4-methoxybenzenediazonium hexafluorophosphate, benzenediazonium tetrafluoroborate and toluenediazonium tetrafluoroarsenate;
aryliodonium salts, such as diphenyliodonium hexafluoroarsenate;
arylsulfonium salts, such as triphenylsulfonium hexafluorophosphate, benzene- and toluenesulfonium hexafluorophosphate and bis[4-diphenylsulfoniophenyl]sulfide bishexafluorophosphate;
disulfones, such as diphenyl disulfone and phenyl 4-tolyl disulfone;
diazodisulfones;
imidotriflates;
benzoin tosylates;
isoquinolinium salts, such as N-ethoxyisoquinolinium hexafluorophosphate;
phenylpyridinium salts, such as N-ethoxy-4-phenylpyridinium hexafluorophosphate;
picolinium salts, such as N-ethoxy-2-picolinium hexafluorophosphate;
ferrocenium salts and titanocenes.

If the presence of a photoinitiator is required, it is used, as a rule, in amounts of from 0.1 to 10, preferably up to 8,% by eight, based on the binder.

When radiation-curable binders are used, subsequent curing of the binder can be carried out in a manner known per se, with the aid of high-energy radiation. For this purpose, the leather is exposed either under an inert gas atmosphere, for example under nitrogen, to electrons (electron beam curing) or to high-energy electromagnetic radiation, preferably in the wavelength range from 220 to 450 nm. The chosen light intensities should be adapted to the curing rate in order to avoid a build-up of the colorant. At a lamp power of from 210 to 240 W/cm, the curing rate may be up to 100 m/min, depending on the type and concentration of the photoinitiator.

In the case of the thermally curable binders, the crosslinking is as a rule effected via polycondensation or polyaddition reactions. Such binders are likewise known as such and are described, for example, in Glasurit-Handbuch Lacke und Farben of BASF Farben und Fasern A G, Vincentz Verlag Hannover, 1984, and in Lackharze—Chemie, Eigenschaften, Anwendungen, Karl-Ranser-Verlag, Munich, Vienna, 1996.

For example, binders crosslinking by polycondensation and based on methylol-containing acrylates are particularly suitable.

Examples of preferred systems are mixtures of
from 1 to 10% by weight of N-methylol(meth)acrylamide or its C₁-C₄-alkyl ethers and, if desired, monomers containing halohydrin groups, such as 2-hydroxy-3-chloropropylene acrylate, and
from 90 to 99% by weight of comonomers, for example from the group consisting of butadiene, styrene, (meth)acrylic acid, (meth)acrylonitrile, (meth)acrylic and vinyl esters of up to 12 carbon atoms, vinyl chloride and N-vinylpyrrolidone,
   as described, for example, in DE-A 16 19 656.

Under the action of acids or the action of compounds which donate protons under the influence of heat, such as ammonium phosphates, the methylol-containing acrylic acid derivatives produce additional crosslinking.

Examples of air-drying binders in which aliphatic double bonds are oxidatively crosslinked by the action of atmospheric oxygen are drying oils, such as linseed oil, wood oil and safflower oil.

Further examples of suitable thermally curable binders are binders based on polyurethane prepolymers.

The binders preferably contain one or more additives, for example leather dyes, for example the Luganil® grades. Further possible additives are casein, commercially available as acid casein and rennet casein, collagen hydrolysis products, or expandable polymers, for example of the Microspheres type, in particular the Expand® grades.

In a preferred embodiment of the present invention, the content of binder or binders in these dispersions or emulsions is at least from 10 to 60% by weight. Usually, the binder is used in an amount, calculated on the basis of the solids content of polymerizable compound, which is at least sufficient exactly to fill the tears, holes and cavities.

In a further embodiment of the present invention, development by the action of IR or microwave radiation or of high-energy electromagnetic radiation is carried out.

The binder or binders can be selectively introduced into the cavities calculated in step (d). For this purpose, a nozzle head is mounted on the same or on a further movable unit, preferably a carriage, and movable unit and nozzle head are controlled with the aid of a further program which takes the data from step (d). The carriage and the nozzle head can be controlled by a program which is known from inkjet technology. Other programs which are known for controlling nozzle heads and are suitable for the novel method are known from industrial robots and from combinatorial chemistry and are commercially available.

The nozzle head is connected, for example by tubes or by automatically controlled pipettes, to a storage container which contains the binder or binders which is or are transported, for example, by means of an automatically controlled pump to the nozzle head. For example, syringes are present at the nozzle head.

In another preferred embodiment of step (e), the dispersion of the binder or binders is applied over a large area of the leather, for example by roll-coating, and a source of actinic radiation, for example a laser, is mounted on the carriage. The source of actinic radiation is then automatically moved over the leather with the aid of the abovementioned program and cures the binder or binders at sites of rawhide damage. The uncured amounts are then removed, for example by washing away with water.

The binder or binders can be applied with the aid of the airbrush technology, airless technology, high volume low pressure technology, hotmelt adhesive technology, roll-coater application technology or casting technology methods known as such in principle from the prior art. The methods as such are discussed, for example, in Bibliothek des Leders, edited by H. Herfeld, Volume 6, Lederzurichtung—oberflächenbehandlung des Leders, Volume 7, Rationalisierung der Lederherstellung durch Mechanisierung und Automatisierung—Gerbereimaschinen.

In a further preferred embodiment of the present invention, step (e) is carried out in such a way that the binder or binders is or are applied in the form of a solid powder or a solid film to the leather and then selectively cured at the site of the rawhide damage by computer-controlled action of actinic radiation or heat. The application of binder powders is preferably effected by methods known from powder injection molding.

In this embodiment of the present invention too, uncured binder can be washed away or sucked up; where a film is used, the film is removed by simply peeling off.

In a further variant of the novel method which starts from rawhide damage comprising coarse defects, i.e. in the context of the present invention those defects which altogether account for more than 10% of the leather surface, determined in (c) and (d), thickener is added to the binder and the thickened binder is stuccoed by an automated procedure with a resolution which is lower compared with step (e). By means of the variant of the novel method, the consumption of filling compound is substantially lower than in the case of conventional stuccoing; moreover, the proportion of natural grain is higher. By optional subsequent polishing or treatment of the leather by the airbrush method, a leather is obtained which, in spite of coarse rawhide damage, has a high proportion of up to 90% of natural grain.

In a particular embodiment of the present invention, the leather produced by the novel method is embossed or provided with pores or a topcoat is applied.

In a further particular embodiment of the novel method, the color of the prepared leather is additionally determined in step (b) and is evaluated calorimetrically by a computer program. This embodiment can be extended by additionally adding a calculated amount of leather dye and/or leather pigment to the binder and automatically correcting the color errors in step (e).

A further aspect of the present invention is an apparatus for carrying out the novel method, comprising one or more sensor units, a movable unit on which the sensor unit or the sensor units is or are mounted, optionally one or more light sources or radiation sources, the sensor unit or sensor units, the movable unit or movable units and the optionally present light source or light sources being connected to a computer which controls the components of the apparatus. The apparatus can be supplemented by a cutter which is likewise connected to the computer. The apparatus may furthermore be supplemented by a nozzle head which is mounted on the same or a further movable unit, the further movable unit being connected to the computer and the nozzle head being connected to the computer and a reservoir stock of binder, the computer controlling the nozzle head and the optionally present further movable unit. The reservoir of binder may be present, for example, in a bottle and may be metered, for example with the aid of a pump, to the nozzle head. The apparatus described above is particularly suitable for carrying out the novel method.

A further aspect of the present invention relates to sheet-like materials which are obtainable by the novel method.

A further aspect of the novel method relates to leathers having natural grain, which are obtainable by the novel method. In the context of the present invention, leathers having natural grain are those leathers in which more than 90, preferably more than 95, particularly preferably more than 98,% by weight, based on the shaved weight, of the natural grain have been retained, i.e. the losses due to buffing are not more than 10, preferably not more than 5, particularly preferably not more than 2, in particular from 0 to 0.05,% by weight. Moreover, the additions of binder mixtures are not more than 10, preferably not more than 8, particularly preferably not more than 5, in particular from 0 to 0.05,% by weight, based on the shaved weight.

The invention is illustrated by way of examples.

### EXAMPLE 1

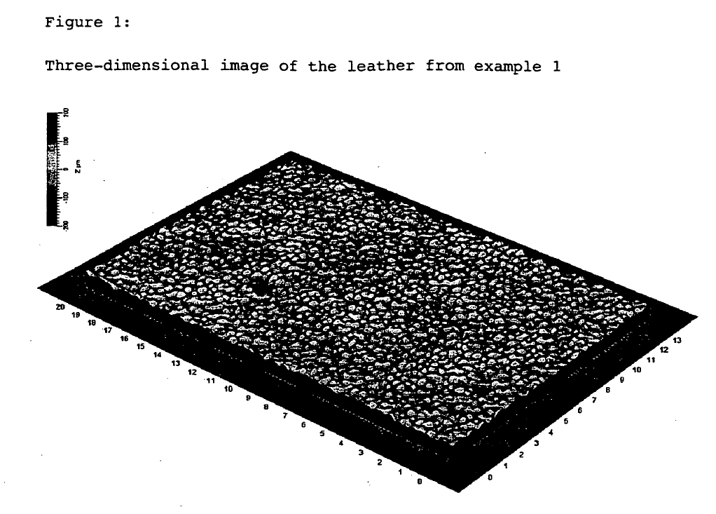

A 13 mm×22 mm leather piece (cattle leather from South German cattle, water content: 35% by weight) was tanned and sammed and then fixed on a vacuum table as described in DE-A 198 22 224. A CCD camera was mounted on a carriage which was connected to a computer. The leather was surveyed by means of a topographical 3D measuring technique, and the surface image shown in FIG. 1 was calculated with the aid of a computer program (OptoCAT program).

Two defect areas having a depth of 150 μm and 200 μm, calculated relative to the plane of fit, were found. The characteristic quantities for defects 1 were: radius r₁=0.15 mm, area A₁=0.07 mm², volume V₁=0.007 mm³; the characteristic quantities for defects 2 were: radius r₂=0.2 mm; area A₂=0.13 mm²; volume V₂=0.017 mm³; in each case, hemispherical defects were used as a basis for calculating the volumes.

The program classified the leather in the present form as being unsuitable in principle for the production of high-quality shoes.

The volume data with the corresponding x,y positional data were transmitted by means of the computer to the control unit of the carriage, and 0.007 and 0.017 mm³, respectively, of a polyacrylate dispersion of the Corialgrund® IF type was applied as a binder, commercially available from BASF Aktiengesellschaft, to the relevant areas with the aid of a nozzle head fastened on the carriage and controlled by the abovementioned computer and was thermally cured.

After the curing and a standard finishing for upper leather, the defect areas were no longer detectable visually and haptically. The leather was now suitable in principle for the production of high-quality shoes.

### EXAMPLE 2

A further 13 mm×22 mm leather piece was surveyed. Two defect areas having a depth of 160 μm and 250 μm, calculated relative to the plane of fit, were found. The characteristic quantities for defects 1 were: radius r₁=0.10 mm, area A₂=0.03 mm², volume V₁=0.002 mm³; the characteristic quantities for defects 2 were: radius r₂=0.25 mm; area A₂=0.20 mm²; volume V₂=0.033 mm³; in each case hemispherical defects were used as a basis for calculating the volumes.

The program classified the leather in the present form as being unsuitable in principle for the production of high-quality shoes.

The volume data with the corresponding x,y positional data were transmitted by means of the computer to the control unit of the carriage, and 0.002 and 0.033 mm³, respectively, of a binder mixture was applied to the relevant areas with the aid of a nozzle head fastened on the carriage and controlled by the abovementioned computer and was thermally cured. The binder mixture had been mixed from the following components:

| | |
|---|---|
| 100 parts by weight | of the pigment Lepton Colours ® N, |
| 100 parts by weight | of the filler Lepton Filler CEN, |
| 50 parts by weight | of the casein dulling agent Luron |
| | Matting; |
| 100 parts by weight | of the polyacrylate binder Corila ® |
| | Binder DN; |
| 175 parts by weight | of Astracin ® Finish PUM; |
| 125 parts by weight | of Astacin ® Finish PFM (two binders |
| | based on polyurethane); |
| 6 parts by weight | of Astacin ® curing agent CN (curing |
| | agent based on isocyanate). |

The upper four components are commercially available from BASF Aktiengesellschaft, and the other three components from Elastogran GmbH.

After the curing, the defect areas were no longer detectable visually and haptically.

The leather was now suitable in principle for the production of high-quality shoes.

1-17. (canceled)

18. A method of upgrading sheet-like materials, comprising the following steps:
(a) preparation of a material,
(b) optoelectronic recording of the surface of the material,
(c) determination of the number of defects,
(d) determination of the volume of defects, and
(e) repairing defects in the form of cavities using one or more binders.

19. A method as claimed in claim 18, wherein the sheet-like material is leather.

20. A method as claimed in claim 19, wherein hides with rawhide damage and/or surfacial manufacturing defects are used as starting material.

21. A method as claimed in claim 18, wherein one or more cameras are used in step (b).

22. A method as claimed in claim 18, wherein one or more sensor units, mounted on a movable unit and computer-controlled, are moved over the prepared surface.

23. A method as claimed in claim 18, wherein small projections of the material are selectively cut off by means of a cutter, which may likewise be mounted on the movable unit.

24. A method as claimed in claim 18, wherein the binders are selected from the group consisting of physically curable binders, thermally curable binders, binders curable by actinic radiation and combinations thereof.

25. A method as claimed in claim 24, wherein radiation-curable binders are selected from the group consisting of acrylate-containing monomers, vinyl-containing monomers, urethane-containing monomers, epoxide-containing monomers, prepolymers, polymers and mixtures thereof.

26. A method as claimed in any of claim 18, wherein, in step (e), the binder or binders is or are selectively introduced into the cavities determined in steps (b) to (d) and then cured.

27. A method as claimed in claim 19, wherein, in step (e), in each case from 95 to 105% by volume, based on the volume of cavities in the leather and in each case based on the solids content of the cured binder, of binder are introduced into the cavities determined and calculated in steps (b) to (d).

28. A method as claimed in claim 20, wherein the binder or binders is or are applied over a large area of the leather, then cured selectively in the area of the rawhide defects and/or of the surfacial manufacturing defects and finally the uncured binder is removed.

29. A method as claimed in claim 18, wherein one or more additives are added to the binder.

30. A method as claimed in claim 19, wherein leather having coarse surface defects is used as a starting material and, in step (e), thickener is added to the binder and the leather is stuccoed with reduced resolution.

31. A leather comprising more than 90% by weight of natural grain, obtainable by a method as claimed in claim 18.

32. A leather as claimed in claim 31, obtainable from leather with rawhide damage or surfacial manufacturing defects.

33. An apparatus for carrying out a method as claimed in any of claim 18, comprising a compouter, a reservoir vessel, a reservoir of binder, one or more sensor units, one or more movable units on which the sensor unit or sensor units is or are mounted, optionally one or more light sources, the sensor unit or sensor units, the movable unit or movable units and the optionally present light source or light sources being connected to a computer which controls the components of the apparatus.

34. An apparatus as claimed in claim 33, further comprising a nozzle head which is mounted on the same or a further movable unit, the further movable unit being connected to the computer and the nozzle head being connected to the computer and a reservoir of binder, the computer controlling the nozzle head and the optionally present further movable unit.
